(19) United States
(12) Patent Application Publication
(10) Pub. No.: US 2026/0326978 A1
(43) Pub. Date: Oct. 22, 2026

(54) PLASTIC TUBE MULTILAYER STRUCTURE

(71) Applicant: AISAPACK HOLDING SA, Vouvry (CH)

(72) Inventors: Jacques THOMASSET, Neuvecelle (FR); Gilles DEMAUREX, Martigny (CH); Rémy CASANOVA, Evian les Bains (FR)

(21) Appl. No.: 18/881,028

(22) PCT Filed: Jul. 4, 2023
(86) PCT No.: PCT/IB2023/056920

§ 371 Date: Jan. 3, 2025

(30) Foreign Application Priority Data
Jul. 5, 2022 (EP) 22183206.6

(51) Int. Cl. B65D 35/08; B29C 48/00; B29C 48/09; B29C 48/154; B29K 23/00; B29K 105/26; B29L 31/00; B32B 1/08; B32B 27/08; B32B 27/32; B65D 23/08

(52) U.S. Cl. CPC B65D 35/08; B29C 48/0021; B29C 48/09; B29C 48/154; B32B 1/08; B32B 27/08; B32B 27/32; B65D 23/0864; B29K 2023/065; B29K 2105/26; B29K 2995/0067; B29K 2995/0097; B29L 2031/7158; B32B 2250/242; B32B 2305/70; B32B 2307/7244; B32B 2307/7376; B32B 2439/60

(57) ABSTRACT

The invention concerns a tubular body (1) obtained by an extrusion and labelling process comprising the following successive steps: (a) forming a partially or totally tubular label (3) from a film comprising mostly a resin, (b) continuously introducing the label (3) into a calibration element, (c) continuously extruding or co-extruding a layer (2) on the side of the concave face of the label (3), said layer comprising mostly a resin, the resin of the extruded layer (2) and the resin of the label (3) being of the same kind, (d) continuously bringing the layer (2) into contact with the concave face of the label (3), step (c) being carried out in the calibration element while the label is going through the calibration element.

### CORRESPONDING APPLICATION

The present application claims priority to earlier European application N° EP22183206.6 filed on Jul. 5, 2022 in the name of AISAPACK HOLDING SA, the content of this earlier application being incorporated by reference in its entirety in the present application.

### FIELD OF THE INVENTION

The invention lies in the field of tubular packaging and in particular that of flexible tubes for liquid or viscous products. It more precisely concerns labelled flexible tubes suitable for recycling and manufactured by the extrusion and labelling process described in the publications WO2015/159234A1, WO2018/051235A1 and WO2018/203210A1, the content of those publications and in particular the processes described therein being incorporated by reference in their entirety in the present application.

### PRIOR ART

Tubular bodies made by extrusion and labelling are used for making unwelded labelled packagings such as flexible tubes for liquid or viscous products or such as cartridges for glue or mastic. These packagings and the method of manufacturing same by extrusion and labelling are described in the publications mentioned hereinabove.

The publication WO2015/159234A1 describes the process and device for manufacturing these packagings by extrusion and labelling as well as the packaging obtained.

The publication WO2018/051235A1 describes a manufacturing process in which the label comprises at least two layers one of which has a melting point that is at least 20° C. higher than the melting point of the extruded tubular body.

The publication WO2018/203210A1 describes a flexible skirt obtained by extrusion and labelling exhibiting elastic behaviour, that is to say it recovers its initial shape after deformation. That skirt features a label the tensile strength of which is greater than 3500 N/mm² and an extruded layer the tensile strength of which is less than 1200 N/mm².

The prior art publications and in particular those mentioned hereinabove do not teach how to make a recyclable packaging by extrusion and labelling. In particular the prior art does not teach now to produce a tubular body by extrusion and labelling with a label and an extruded body that are formed using resins of the same family to enable recycling thereof. In the publication WO2015/159234 for example although a plurality of materials are mentioned for the extruded part and the label, in concrete realisations thereof the label comprises at least one layer the melting point of which is greater than 160° C. and at least one layer of the same kind as the extruded tubular body. To be more precise, in the examples, for a polyethylene (PE) tubular body, a PET/PE, PE/PET/PE, PA/PE, Alu/PE, PE/Alu/PE, Papier/PET/PE label is used. None of these structures can be recycled easily because of the mixture of materials used to make them. The same problem of mixing of materials is encountered in the publication WO2018/051235 with the same combinations making recycling difficult and necessitating separation of the layers beforehand.

An identical problem arises in the publication WO2018/203210 that describes mixtures of different materials for the main layer.

Thus there exists a need to develop processes and means making it possible to obtain packaging that can mostly or entirely be recycled at the end of life in a simple manner and without treatment of the preliminary packaging before its recycling, for example to separate the layers thereof or the components thereof (body, label, shoulder, cap, etc.).

### GENERAL DISCLOSURE OF THE INVENTION

The invention makes it possible to overcome the aforementioned disadvantages by proposing a tubular body made by extrusion and labelling that is easily recyclable. The tubular body according to the invention in one embodiment is produced by means of the processes described in the publications identified hereinabove the content of which is incorporated by reference into the present application. For example, in embodiments of the invention the process from WO2015/159234A1 is used in which the tubular body is obtained by an extrusion and labelling process comprising the following successive steps:
(a) forming a partially or totally tubular label from a film composed of recyclable resin,
(b) introducing the label into a calibration element,
(c) extruding a layer on the side of the concave face of the label,
(d) bringing the layer into contact with the concave face of the label, step (c) being carried out in the calibration element.

The above publication is incorporated by reference in its entirety where the method described therein is concerned.

Generally speaking, the invention may be used to increase productivity because the material melted and extruded is no longer in direct contact with the surface of the calibration element. The rubbing of the melted and extruded material on the calibration element that is encountered in a standard extrusion process is eliminated so that the production rate can be increased.

The packagings resulting from this manufacturing process offer very high cohesion between the label and the tubular body. The risks of the label becoming unstuck during use of the packaging are eliminated in contrast to prior art packaging produced with an adhesive label that is applied afterwards to an extruded body.

The invention also enables production of decorated tubes of small or large diameter. It offers very high flexibility, and may be used in new extrusion installations or enables modification and adaptation of existing installations.

The principle of the invention and embodiments thereof are defined in the claims at the end of the present description.

According to embodiments, the present invention concerns a tubular body obtained by an extrusion and labelling process comprising the following successive steps:
(a) forming a partially or totally tubular label from a film comprising mostly a resin,
(b) continuously introducing the label into a calibration element,
(c) continuously extruding or co-extruding a layer on the side of the concave face of the label, said layer comprising mostly a resin, the resin of the extruded layer and the resin of the label being of the same kind,
(d) continuously bringing the layer into contact with the concave face of the label,
wherein step (c) is carried out in the calibration element while the label is going through the calibration element, and wherein the content of resin of the same kind is greater than 70%.

According to embodiment, the invention concerns a method of extruding and labelling comprising the following successive steps:
(a) forming a partially or totally tubular label from a film comprising mostly a resin,
(b) continuously introducing the label into a calibration element,
(c) continuously extruding or co-extruding a layer on the side of the concave face of the label, said layer comprising mostly a resin, the resin of the extruded layer and the resin of the label being of the same kind,
(d) continuously bringing the layer into contact with the concave face of the label,
wherein step (c) is carried out in the calibration element while the label is going through the calibration element, and wherein the resin of the same kind is greater than 70%.

According to embodiments of the invention, the label and the extruded material forming the tubular body comprise mostly resins of the same kind in order to enable recycling of the packaging at its end of life.

According to embodiments of the invention, the tubular body is mostly based on resins of the same kind enabling recycling; the content of resins of the same kind in the labelled tubular body being preferably greater than 85% and advantageously greater than 95%.

In embodiments, the tubular body is based mainly on polyethylene, the content of polyethylene in the labelled tubular body being greater than 70%, preferably greater than 85% and advantageously greater than 95%.

In embodiments, the tubular body is based mostly on HDPE, the content of HDPE in the labelled tubular body being greater than 70%, preferably greater than 85% and advantageously greater than 95%.

In embodiments, when the tubular body is recycled with HDPE bottles the tubular body 1 comprises mostly HDPE the mass flow rate of which, that is to say its MFR (190° C., 2.16 kg, measured in accordance with the standard ISO 1133) is less than 4 and preferably less than 1.

In embodiments, the tubular body is based mostly on polypropylene, the content of polypropylene in the label tubular body being greater than 70%, preferably greater than 85% and advantageously greater than 95%.

In embodiments, the tubular body is made at least in part from recycled resins. The tubular body may contain one or more layers of recycled resins. For reasons of foodstuff compatibility it is generally recommended to prevent the recycled layers from forming the internal layer of the packaging and being located in contact with the packaged product.

In embodiments, the labelled tubular body is made from recycled polyethylene, the content of recycled polyethylene being greater than 30%, preferably greater than 50% and advantageously greater than 70%.

In embodiments, the labelled tubular body is made from recycled polypropylene, the content of recycled polypropylene being greater than 30%, preferably greater than 50% and advantageously greater than 70%.

In accordance with the invention, in embodiments, the external surface of the labelled tubular body has a coefficient of friction on stainless steel less than 0.25, preferably less than 0.2 and advantageously less than 0.17 (standard ISO 8295).

In accordance with the invention, in embodiments, the tubular body advantageously has a variation of thickness at the level of the internal surface and located in alignment with the edge of the label, said thickness variation forming a bead or a recess.

In embodiments, the variation of thickness forms a bead, the thickness of the bead being between 1% and 30% of the total thickness and preferably between 5% and 20% of the total thickness.

In accordance with the invention the bead enables increased circumferential strength of the tubular body at the level of the discontinuity created by the edges of the label.

In embodiments, the thickness variation forms a recess, the depth of the recess being between 1% and 30% of the total thickness and preferably between 5% and 20% of the total thickness.

In accordance with the invention the recess enables a reduced circumferential strength of the tubular body at the level of the edges of the label to facilitate opening of the tubular body at its end of life.

In accordance with the invention, in embodiments, the width of the bead or of the recess is between 0.5 mm and 10 mm and preferably between 1 mm and 5 mm.

In embodiments, the edges of the label are disposed end-to-end and are separated by a gap between 0 and 2 mm, preferably between 0 and 500 microns and advantageously between 0 and 100 microns.

In embodiments, the edges of the label overlap and form an overlap of between 0 and 2 mm, preferably between 0 and 500 microns and advantageously between 0 and 100 microns.

In embodiments, a strip located between the label and the extruded resin connects the edges of the label, the width of said strip being between 2 mm and 10 mm and preferably between 3 mm and 7 mm.

In embodiments, a strip located on the external surface of the tubular body connects the edges of the label, the width of said strip being between 2 mm and 10 mm and preferably between 3 mm and 7 mm.

In accordance with the invention, in embodiments, the tubular body advantageously comprises a barrier layer to oxygen and/or odours and/or substances able to migrate into the packaging.

The tubular body according to the invention has high resistance to stress cracking as well as providing a strong barrier to water vapour or to oxygen.

In embodiments, the extruded layer is advantageously formed of a resin or a mixture of resins particularly resistant to stress cracking. The MFR (190° C., 2.16 kg, measured according to the standard ISO 1133) of the resin or the mixture of resins forming the layer is less than 50, preferably less than 25 and advantageously less than 4.

In embodiments, the thickness of the tubular body is preferably between 150 and 1500 microns and in particular between 200 and 1200 microns.

In embodiments, the thickness of the label is between 10 and 120 microns and preferably between 20 and 80 microns. Other dimensions are of course possible. The label 3 preferably covers all of the surface of the tubular body.

The tubular body according to the invention advantageously provides an excellent barrier to water vapour as well as to oxygen. The barrier to water vapour of the tubular body is less than 0.1 and preferably less than 0.05 g/tube/day/100% H₂O. The tubular body also has a permeability to oxygen less than 6 cm³/tube/day/bar and preferably less than 0.75. The barrier to oxygen is advantageously provided by the label. Many solutions exist for imparting barrier to oxygen properties. The label may for example contain a dual-oriented or metallised layer or a layer with an SiOx coating. Other barrier layers such as EVOH, PA layers widely used in the packaging field may also be used provided that these layers because of their nature or their proportions do not reduce the recyclability of the tubular body.

In embodiments, the labelled tubular body comprises at least one barrier layer located in the label, the thickness of said barrier layer representing less than 10%, preferably less than 5% and advantageously less than 1% of the total thickness.

In embodiments, the labelled tubular body comprises at least one barrier layer located in the extruded layer. In accordance with the invention the thickness of the barrier layer represents less than 10%, preferably less than 5% and advantageously less than 2% of the total thickness.

In embodiments, the barrier layer may be a layer of EVOH resin or a metallised layer or an SiOx layer.

The invention offers several advantages where the appearance of the tubular body and consequently the appearance of the packaging is concerned. It is possible to produce a glossy or matt tubular body surface by modifying the choice of the label and in particular of the layer of varnish on the surface of the label.

The invention enables complete decoration of the tubular body to be obtained. In accordance with embodiments of the invention, the label extends around all of the tubular body in the radial direction. It is possible to apply the label so that it completely surrounds the tubular body in the circumferential direction without leaving a gap between the edges of the label. It is therefore possible to produce a continuous pattern or an uninterrupted text that extends around the circumference of the body of the tubular body with no visible join between the edges of the decorated label.

It may also be advantageous for the decoration of the label to cover all of the tubular body in the axial direction.

In embodiments, the invention concerns a product, such as a packaging, comprising at least one tubular body as defined in the present application. The product may be a tube or a bottle or a cartridge or some other form of packaging or some other object.

### Definition of the Terms Used in the Disclosure of the Invention

The following terms and abbreviations are used in the disclosure of the invention:
Label: thin film including one or more layers and forming the external surface of the tubular body. The external face of the label is generally printed and varnished.
PP: polypropylene
HDPE: high-density polyethylene
EVOH: ethylene vinyl alcohol.
Bead: local increased thickness of the wall of the tubular body located in line with the edges of the label
Recess: local reduced thickness of the wall of the tubular body located in line with the edges of the label.
Strip: thin film connecting the edges of the label

### DETAILED DESCRIPTION OF THE INVENTION

The invention will be better understood from the description of non-limiting embodiments thereof and the appended FIGURES in which

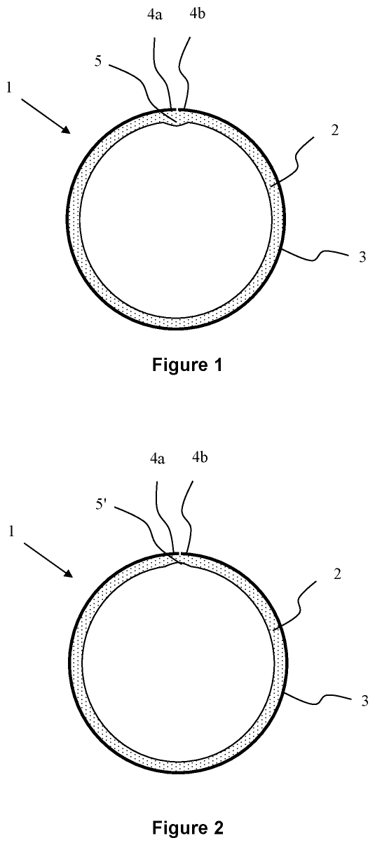

FIGS. 1 and 2 illustrate in section preferred embodiments of tubular bodies according to the invention in which the edges of the label are disposed end-to-end.

FIG. 1 illustrates an embodiment of the invention in which the wall of the tubular body features a bead in line with the edges of the label.

FIG. 2 illustrates an alternative embodiment in which the wall of the tubular body features a recess in line with the edges of the label.

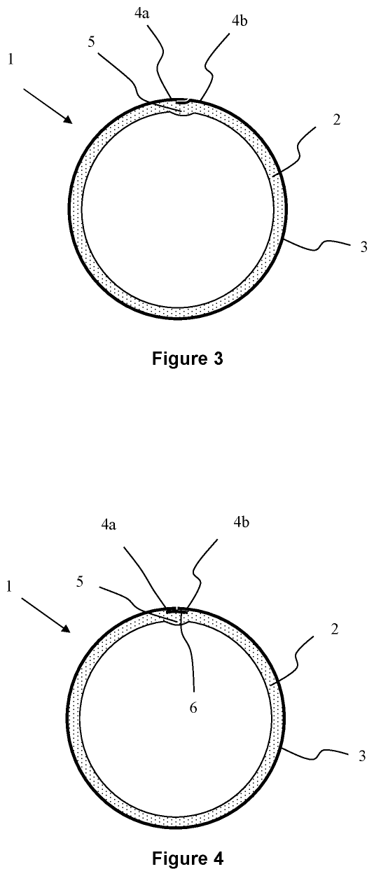

FIG. 3 illustrates another embodiment of the tubular bodies in which the edges of the label overlap.

FIG. 4 illustrates another embodiment of the tubular bodies in which a strip 6 is fixed to the internal face of the label and connects said edges.

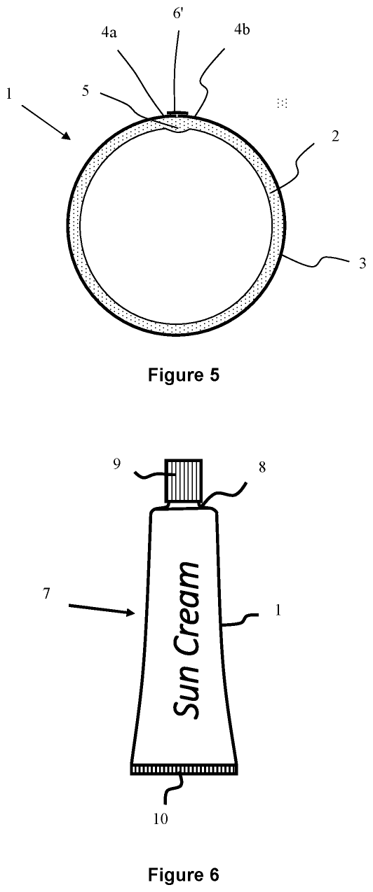

FIG. 5 illustrates another embodiment of the tubular bodies in which a strip 6 is fixed to the external face of the label and connects said edges.

FIGS. 6 to 8 illustrate recyclable packagings comprising a tubular body 1 produced in accordance with the invention.

FIG. 6 illustrates a recyclable flexible tube for liquid or viscous products such as toothpastes, cosmetic products or food products.

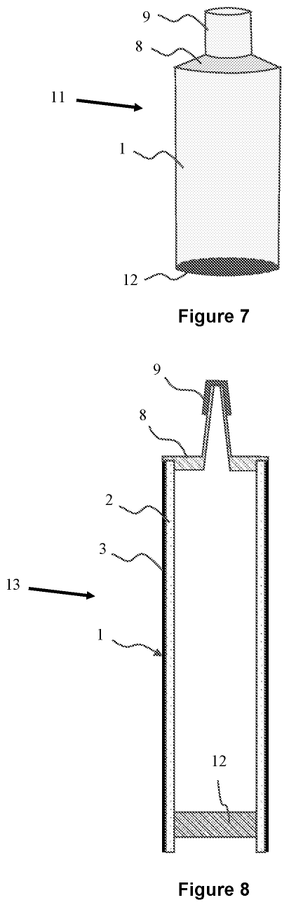

FIG. 7 illustrates a recyclable bottle comprising a tubular body 1 produced in accordance with the invention. The bottle enables delivery of liquid products such as cosmetic creams or lotions or food products such as juices.

FIG. 8 illustrates a recyclable single-material cartridge comprising a tubular body 1 produced in accordance with the invention. The cartridge enables delivery of viscous products such as glues or mastics.

The invention relates in particular to the flexible or rigid tubular part of the packaging made by extrusion and labelling and referred to as the tubular body in the present description.

The production of recyclable tubular bodies, that is to say comprising mostly resins of the same kind (label and extruded layer), in particular demands specific properties on the label. In particular, it has been determined by experiment that the coefficient of friction of the external surface of the label in the tool for manufacturing the tubular body must be less than a critical value beyond which there is seen a rupture of the label rendering impossible the production of the tubular body or production with a high level of defective packaging.

In accordance with the invention, it has been determined by experiment that the external surface of the label should ideally have a coefficient of friction on stainless steel less than 0.25, and preferably less than 0.2 and advantageously less than 0.17, said coefficient of friction being measured in accordance with the standard ISO 8295.

As the label is located on the surface of the tubular body produced, the external surface of said tubular body in accordance with the invention consequently has a coefficient of friction on stainless steel less than 0.25, preferably less than 0.2 and advantageously less than 0.17, the coefficient of friction being measured in accordance with the standard ISO 8295 and in accordance with the values determined by experiment.

As described hereinabove, in accordance with the invention the label and the extruded layer are composed mostly of resins of the same kind in order to enable recycling of the packaging at its end of life.

In accordance with the invention the label represents between 2% and 30% of the thickness of the tubular body and preferably between 5% and 15%. The bead is used to compensate the reduction of properties at the level at the edges of the label; the recess is used to accentuate the reduction of the properties at the level of the edges of the label.

FIG. 1 illustrates a labelled tubular body 1 comprising an extruded layer 2 covered by a label 3 the edges 4a and 4b of which are disposed end-to-end. The external surface of the label, which is also the external surface of the tubular body, has a coefficient of friction on stainless steel less than 0.2.

According to embodiments, the label 3 and the extruded layer 2 are based mostly on polyethylene and preferably on HDPE.

### Example 1

Coefficient of friction of the label on stainless steel: 0.15
Multilayer structure of the label 3:

| | |
|---|---|
| HDPE | 25 microns (printed and varnished external face) |
| Binder | 5 microns |
| EVOH | 10 microns |
| Binder | 5 microns |
| HDPE | 25 microns |

### Extruded Layer 2

Thickness 330 microns
Resin HDPE

The content of HDPE in the tubular body 1 is 95%.

The tubular body 1 is therefore easily recyclable in the HDPE recycling channel.

In accordance with another embodiment the label includes layers of recycled HDPE.

In accordance with another embodiment (example 2) the label is made of recycled HDPE, and the layer 2 is co-extruded and forms a multilayer structure.

### Example 2

### Label 3

Recycled HDPE 70 microns

### Extruded Layer 2 is Multilayer (Co-Extrusion)

| | |
|---|---|
| Recycled HDPE | 370 microns (layer in contact with the label) |
| Binder | 10 microns |
| EVOH | 20 microns |
| Binder | 10 microns |
| HDPE | 20 microns (internal face) |

The percentage of recycled HDPE in the tubular body 1 is 88%. The percentage of virgin HDPE is 4%. The tubular body 1 is therefore easily recyclable in the HDPE recycling channel.

In accordance with other embodiments, the tubular body includes a barrier layer in the label 3 and another one in the layer 2. This embodiment is particularly advantageous for trapping the recycled layer between two barrier layers respectively located close to the internal and external surfaces of the tubular body. This configuration makes it possible to avoid migration of molecules present in the recycled resin toward the internal surface of the tubular body and toward the external surface of the tubular body. The barrier layers are advantageously thin layers such as metallised layers or SiOx layers or layers formed of other equivalent materials.

FIG. 1 illustrates a bead 5 located on the internal face of the tubular body 1 and in line with the edges 4a and 4b of the label 3. The bead compensates at least partially any discontinuity of the circumferential properties of the tubular body at level of the edges of the label. In the example illustrated in FIG. 1 the thickness of the tubular body is 400 microns and the additional thickness created by the bead is 40 microns, i.e. a bead thickness representing 10% of the total thickness. In other embodiments of the invention the thickness of the bead is equal to the thickness of the label, i.e. 60 microns, which corresponds to 15% of the total thickness. In accordance with the invention the thickness of the bead varies between 1% and 30% of the total thickness and preferably between 5 and 20%.

The width of the bead 5 is between 0.5 mm and 10 mm and preferably between 1 mm and 5 mm. The bead 5 makes it possible to improve the resistance of the tubular body 1 to bursting, in particular in the event of an impact.

In accordance with another embodiment of the invention illustrated in FIG. 2 the tubular body 1 has a local reduced thickness of the extruded layer 2 at the level of the edges 4a and 4b of the label 3, forming a recess 5′. The recess 5′ has a depth between 1% and 30% of the total thickness of the wall of the tubular body 1 and preferably a depth between 5% and 20%. The recess 5′ allows to increase the weakness of the tubular body at the level of the edges of the label to facilitate tearing open the tubular body at the end of its life. This enables the user to reduce the residual quantity of product in the packaging before recycling.

For example, for a wall thickness of the tubular body of 300 microns, a depth of the recess 5′ of 30 microns represents 10% of the thickness of the tubular body. To this reduction of thickness is added the discontinuity created by the edges of the label. The local reduction of the properties of the tubular body makes it easier to tear open the tubular body.

FIG. 3 illustrates another embodiment of the invention in which the edges 4a and 4b of the label form an overlap. In the embodiment illustrated in FIG. 3 the extruded layer forms a bead 5 that reinforces the area in which the edges 4a, 4b of the label 3 are superposed.

The overlap is between 0 mm and 2 mm, preferably between 0 and 500 microns and advantageously between 0 and 100 microns.

In embodiments, the edges 4a and 4b of the label 3 are fixed one on the other by welding or gluing. Alternatively, the edges 4a, 4b are not fixed to each other.

In an embodiment that is not illustrated the tubular body 1 features a recess 5′ at the level of its wall at the level of the overlap of the edges 4a, 4b of the label 3.

FIG. 4 illustrates another embodiment of the invention in which an internal strip 6 connects the edges 4a and 4b of the label. The strip 6 is advantageously welded to the internal face of the label. Alternatively, the strip 6 is glued or fixed by other equivalent means. The strip 6 is preferably made using resins identical or similar to those of the label 3 or that of the extruded layer 2 so that the tubular body is easily recyclable in accordance with the principles of the present invention.

In the embodiment illustrated in FIG. 4 the extruded layer 2 forms a bead 5 that reinforces the wall at the level of the edges 4a, 4b of the label 3.

In an embodiment of the invention that is not illustrated the tubular body 1 features a recess 5′ at the level of its wall at the level of the edges 4a, 4b of the label 3 (as illustrated in FIG. 2) instead of the bead 5 from FIG. 4 and therefore combines the recess 5′ and an internal strip 6.

FIG. 5 illustrates another embodiment of the invention in which an external strip 6′ connects the edges 4a and 4b of the label 3. The strip 6′ is advantageously welded to the external face of the label 3. Alternatively, the strip 6′ is glued or fixed by other equivalent means. The strip 7 is preferably made using resins identical or similar to those of the label 3 or that of the extruded layer 2 so that the tubular body 1 is easily recyclable in accordance with the principles of the present invention.

In the embodiment illustrated in FIG. 5 the extruded layer 2 forms a bead 5 that reinforces the wall at the level of the edges 4a, 4b of the label 3.

In an embodiment of the invention that is not illustrated the tubular body 1 features a recess 5′ at the level of its wall at the level of the edges 4a, 4b of the label 3 (as illustrated in FIG. 2) instead of the bead 5 from FIG. 5 and therefore combines a recess 5′ and an external strip 6′.

FIGS. 6 to 8 illustrate examples of packagings produced from tubular bodies 1 in accordance with the invention. These packagings are easily recyclable.

FIG. 6 illustrates a flexible tube 7 intended to contain viscous or paste-like products. The tube 7 features a tubular body 1 produced by extrusion and labelling in accordance with the principles and embodiments of the invention described in detail hereinabove. One end of the tubular body is connected to a head 8 including an orifice for extraction of the product contained in the packaging. The packaging also includes an opening and closing system schematically represented by the cap 9 that is matched to the head 8. The cap 9 and the head 8 may form separable objects such as a cap screwed onto a neck as illustrated in FIG. 6. Alternatively, the closing system 9 and the head 8 are inseparable. The head 8 and the cap 9 advantageously form one and the same object.

In accordance with the invention the flexible tube 7 formed by the tubular body 1, the head 8 and the opening and closing system 9 comprises mostly resins of the same kind in order to enable recycling of the entire packaging at its end of life without having to separate the parts forming the packaging 7 (tubular body 1, head 8 and cap 9). For example, if the tubular body 1 produced in accordance with the invention is based on HDPE the shoulder head 8 and the cap 9 will therefore preferably also be based on HDPE.

In accordance with the invention, the content of resin of the same kind in the complete flexible tube is therefore at least 75%, preferably greater than 85% and advantageously greater than 95%.

In accordance with the principles of the invention the external surface of the flexible tube 7 has a coefficient of friction on stainless steel less than 0.25, preferably less than 0.2 and advantageously less than 0.17 (standard ISO 8295).

FIG. 7 illustrates a bottle intended to contain viscous or paste-like products. The bottle 11 comprises a tubular body 1 produced by extrusion and labelling in accordance with the principles and embodiments of the invention. One end of the tubular body 1 is connected to a head 8 including an orifice for extraction of the product contained in the packaging. A bottom 12 is fixed to the second end of the tubular body 1. The packaging 11 also includes an opening and closing system schematically represented by the cap 9 that is matched to the head 8. The cap 9 and the head 8 may form two separable objects such as a cap 9 screwed onto a neck as illustrated in FIG. 7. The closing system 9 and the head 8 are advantageously connected to one another by an appropriate means (e.g. a tongue).

According to the principles and embodiments of the invention the bottle 11 comprising the tubular body 1, the head 8, the bottom 12 and the opening and closing system 9 comprise mostly resins of the same kind in order to enable recycling of the packaging at its end of life. For example, if the tubular body 1 produced in accordance with the invention is based on PP the shoulder 8, the bottom 12 and the cap 9 are therefore also based on PP.

In accordance with the principles and embodiments of the invention the content of resin of the same kind in the bottle is therefore at least 75%, preferably greater than 85% and advantageously greater than 95%.

In accordance with the principles and embodiments of the invention the external surface of the bottle 11 has a coefficient of friction on stainless steel less than 0.25, preferably less than 0.2 and advantageously less than 0.17 (standard ISO 8295).

FIG. 8 illustrates a cartridge 13 intended to contain viscous or paste-like products such as glues or mastics. The cartridge 13 comprises a tubular body 1 produced by extrusion and labelling in accordance with the invention. One end of the tubular body is connected to a head 8 including an orifice for extraction of the product contained in the packaging 13. The orifice is generally created before use by cutting off the end of the nozzle. A sliding bottom 12 blocks the second end of the tubular body and slides to extract the product it contains. The packaging 13 also includes an opening and closing system schematically represented by the cap 9 that is matched to the head 8. The cap 9 and the head 8 may form two separate objects such as a cap screwed onto a neck as illustrated in FIG. 8. The closing system 9 and the head 8 are advantageously connected to one another by an appropriate means (e.g. a tongue).

In accordance with the principles and embodiments of the invention the cartridge 13 comprising the tubular body 1, the head 8, the bottom 12 and the opening and closing system 9 are made mostly of resins of the same kind in order to enable recycling of the packaging at the end of its life. For example, if the tubular body 1 produced in accordance with the invention is based on HDPE the shoulder 8, the bottom 12 and the cap 9 are also based on HDPE.

In accordance with the invention the content of resin of the same kind in the cartridge 13 is therefore at least 75%, preferably greater than 85% and advantageously greater than 95%.

In accordance with the invention the external surface of the cartridge 13 has a coefficient of friction on stainless steel less than 0.25, preferably less than 0.2 and advantageously less than 0.17 (standard ISO 8295).

The embodiments described in the present application are described by way of illustrative example and must not be considered as limiting on the invention. Other embodiments may employ means or materials equivalent to those described. For example, although the embodiments illustrated in FIGS. 1 to 5 comprise a bead 5 or a recess 5′, the present invention and its principles apply equally to tubular body embodiments with no bead or recess. The embodiments may also be combined with one another as a function of circumstances or means used in one embodiment may be used in another embodiment. The dimensions are also given by way of example or preferred values and may vary as a function of circumstances. Likewise, the materials indicated are indicated by way of illustrative example and other equivalent or appropriate materials may be envisaged.

The present description mainly refers to tubular bodies to form tubes 7, bottles 11, cartridges 13 but other applications are of course possible within the frame of the present invention, for example to form other objects.

1. Tubular body obtained by an extrusion and labelling process comprising the following successive steps:
(a) forming a partially or totally tubular label from a film comprising mostly a resin,
(b) continuously introducing the label into a calibration element,
(c) continuously extruding or co-extruding a layer on the side of the concave face of the label, said layer comprising mostly a resin, the resin of the extruded layer and the resin of the label-being of the same kind,
(d) continuously bringing the layer-into contact with the concave face of the label, step (c) being carried out in the calibration element while the label is going through the calibration element,
the resin of the same kind being greater than 70%.

2. Tubular body according to claim 1, in which the resin is recyclable and/or recycled.

3. Tubular body in accordance with claim 1, said tubular body being based mostly on polyethylene or HDPE or polypropylene or HDPE the mass flow rate of which is less than 4.

4. Tubular body according to claim 1, said tubular body being made at least in part from recycled resins.

5. Tubular body according to claim 1, in which the external surface of label has a coefficient of friction on stainless steel less than 0.25.

6. Tubular body according to claim 1, said tubular body having a variation of thickness at the level of the internal surface and situated in line with the edges of the label, said thickness variation forming a bead or a recess.

7. Tubular body according to claim 6, the thickness of the bead or the depth of the recess being between 1% and 30% of the total thickness.

8. Tubular body according to claim 6, the width of the bead or of the recess is between 0.5 mm and 10 mm.

9. Tubular body according to claim 1, in which the edges of the label are disposed end-to-end and are separated by a gap between 0 and 2 mm.

10. Tubular body according to claim 1, in which the edges of the label overlap and form an overlap between 0 and 2 mm.

11. Tubular body according to claim 1, comprising an internal strip located between the label and the extruded resin that connects the edges of the label, the width of said strip being between 2 mm and 10 mm.

12. Tubular body according to claim 1, comprising an external strip located on the external surface of the tubular body and connecting the edges of the label, the width of said external strip being between 2 mm and 10 mm.

13. Tubular body according to claim 1, comprising at least one layer that is a barrier to oxygen and/or to odours and/or to substances able to migrant into the packaging.

14. Tubular body according to claim 13, said barrier layer being located in the label.

15. Tubular body according to claim 13, said barrier layer being located in the extruded layer.

16. Tubular body according to claim 13, the thickness of said barrier layer representing at least 10% of the total thickness of the label, respectively of the extruded layer.

17. Packaging comprising a tubular body according to claim 1.

18. Packaging according to claim 17, said packaging being a tube or a bottle or a cartridge.

19. Method of extruding and labelling comprising the following successive steps:
(a) forming a partially or totally tubular label from a film comprising mostly a resin,
(b) continuously introducing the label into a calibration element,
(c) continuously extruding or co-extruding a layer on the side of the concave face of the label, said layer comprising mostly a resin, the resin of the extruded layer and the resin of the label being of the same kind,
(d) continuously bringing the layer into contact with the concave face of the label, step (c) being carried out in the calibration element while the label is going through the calibration element,
the resin of the same kind being greater than 70%.
